(19) United States
(12) Patent Application Publication
(10) Pub. No.: US 2009/0271237 A1
(43) Pub. Date: Oct. 29, 2009

(54) Optimizing Rail Shipments for Commodity Transactions

(75) Inventors: Arthur J. Siccardi, JR., Marietta, GA (US); Daniel L. Gordon, Mableton, GA (US); Daniel Luther, Atlanta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: RAIL INSIGHT, LLC, Atlanta, GA (US)

(21) Appl. No.: 12/431,125

(22) Filed: Apr. 28, 2009

Related U.S. Application Data
(60) Provisional application No. 61/048,244, filed on Apr. 28, 2008.

(51) Int. Cl. G06Q 10/00; G06Q 50/00

(52) U.S. Cl. 705/7

(57) ABSTRACT

Embodiments for optimization of at least one previously established rail shipment of a commodity are described herein. More specifically, one embodiment of a method includes receiving data related to a first previously established rail shipment the first previously established rail shipment established via a first supplier and exchanging at least a portion of the first previously established rail shipment with a second previously established rail shipment.

### CROSS REFERENCE

This application claims the benefit of U.S. Provisional Application No. 61/048,244, filed Apr. 28, 2008, which is incorporated by reference in its entirety.

### BACKGROUND

In shipping commodities between a supplier and a recipient, any of a plurality of transit systems may be used. As a nonlimiting example, with regard to the shipment of ethanol, railroads may be primarily used. With regard to shipment of ethanol (and/or other commodities) via rail, there are often efficiency problems in that a first shipment from a first party may be scheduled to go from a first geographical area to a second geographical area and second shipment may be scheduled for shipment from a second party from the second geographical area to the first geographical area. In such situations, the suppliers never realize the inefficiencies of their shipments.

Thus, a heretofore unaddressed need exists in the industry to address the aforementioned deficiencies and inadequacies.

### SUMMARY

Embodiments for optimization of at least one previously established rail shipment of a commodity are described herein. More specifically, one embodiment of a method includes receiving data related to a first previously established rail shipment, the first previously established rail shipment established via a first supplier, and exchanging at least a portion of the first previously established rail shipment with a second previously established rail shipment.

Other embodiments and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

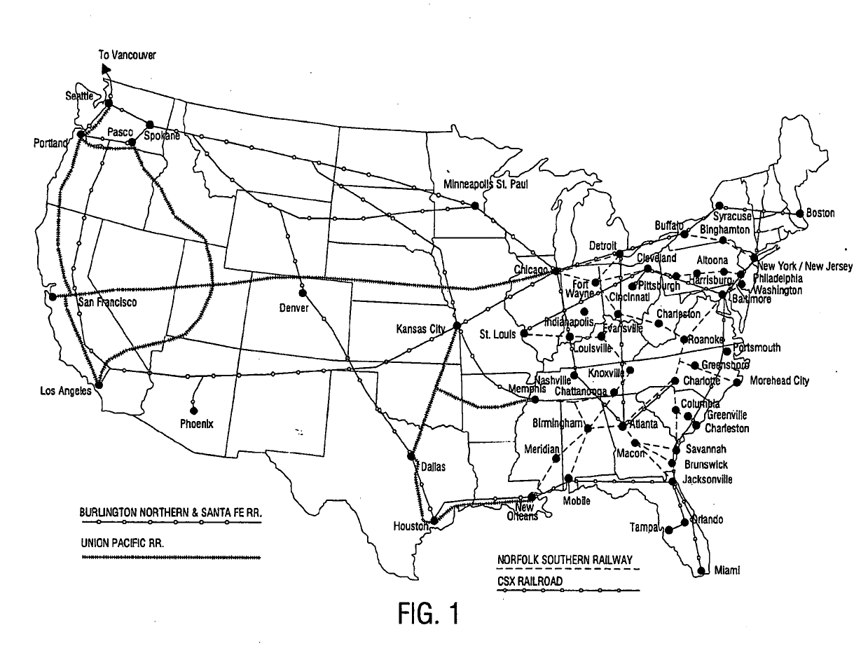

FIG. 1 illustrates an exemplary map, depicting rail lines that may facilitate shipments of commodities.

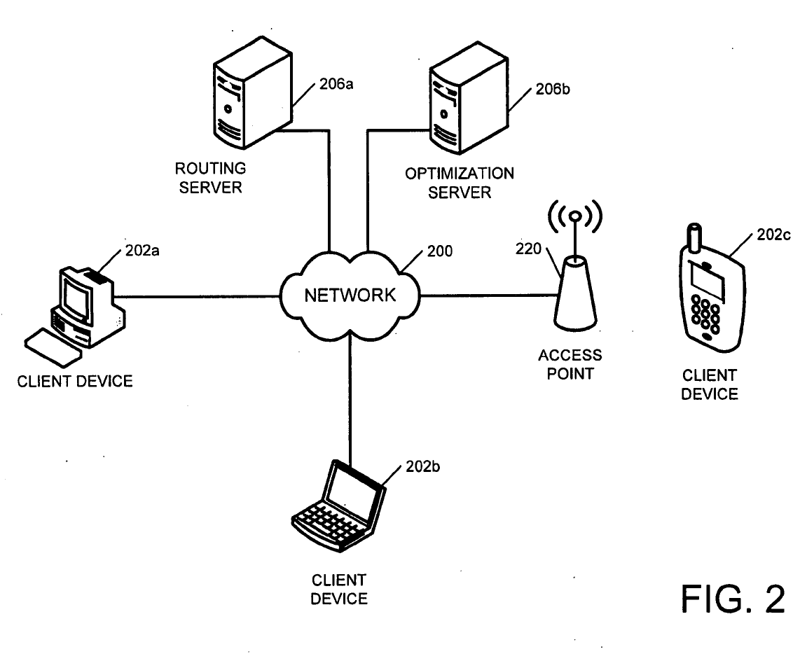

FIG. 2 illustrates an exemplary network that may be utilized for optimizing rail shipments of commodities, such as via the rail lines from FIG. 1.

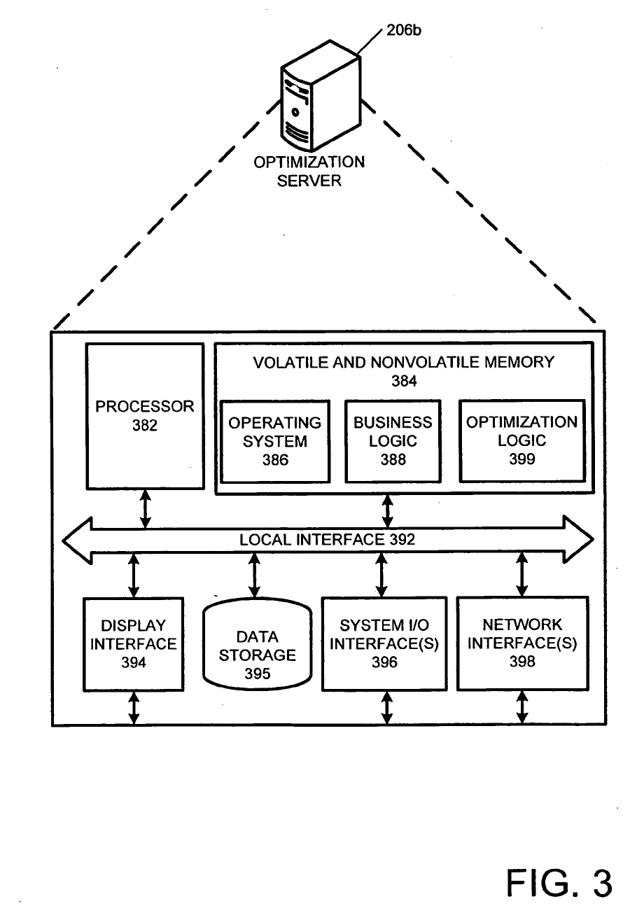

FIG. 3 illustrates an exemplary server that may be utilized for optimizing rail shipments of commodities, such as the optimization server illustrated in FIG. 2.

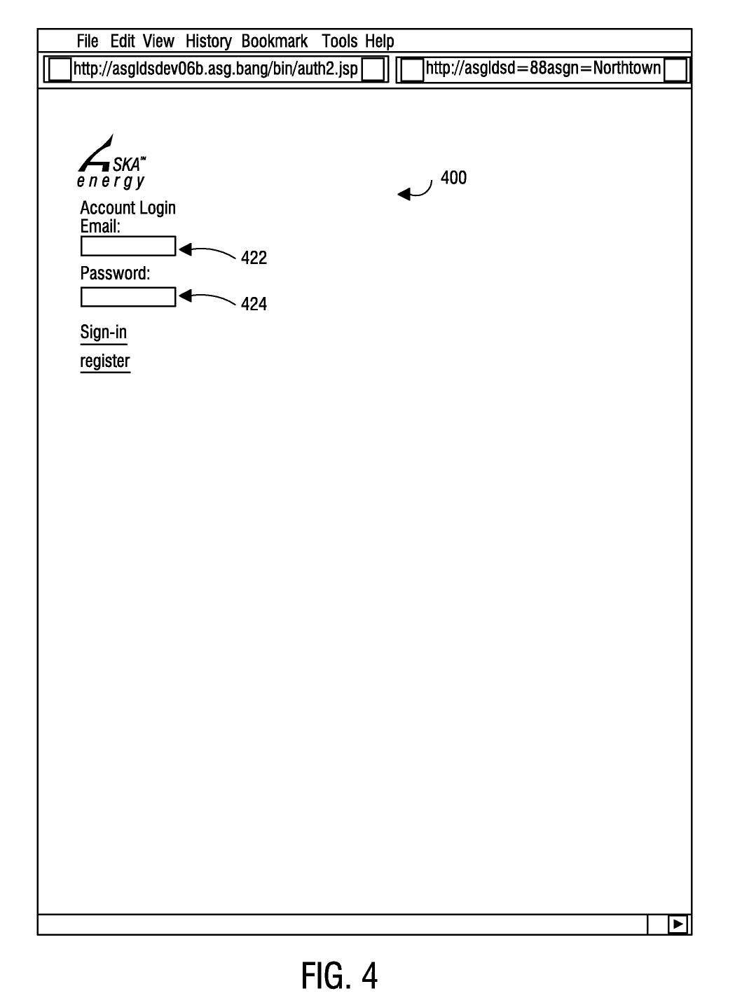

FIG. 4 illustrates an exemplary interface that may be presented to a user and/or technician for optimizing rail shipments of commodities, such as may be presented by the server from FIG. 3.

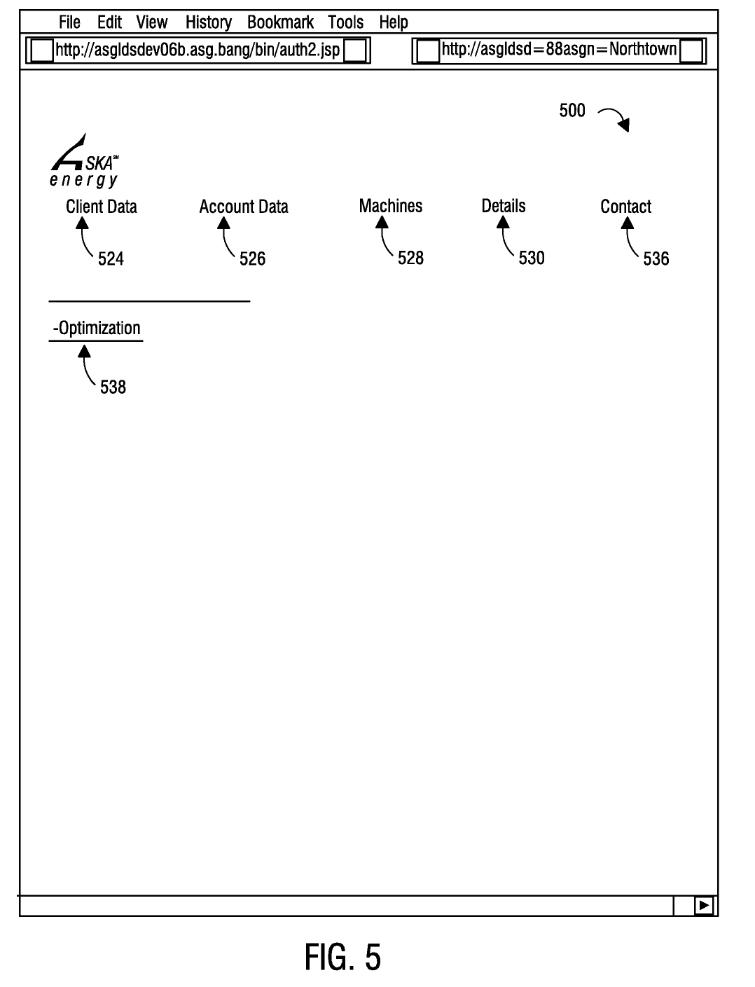

FIG. 5 illustrates an exemplary interface for facilitating utilization of rail shipments of commodities, similar to the interface from FIG. 4.

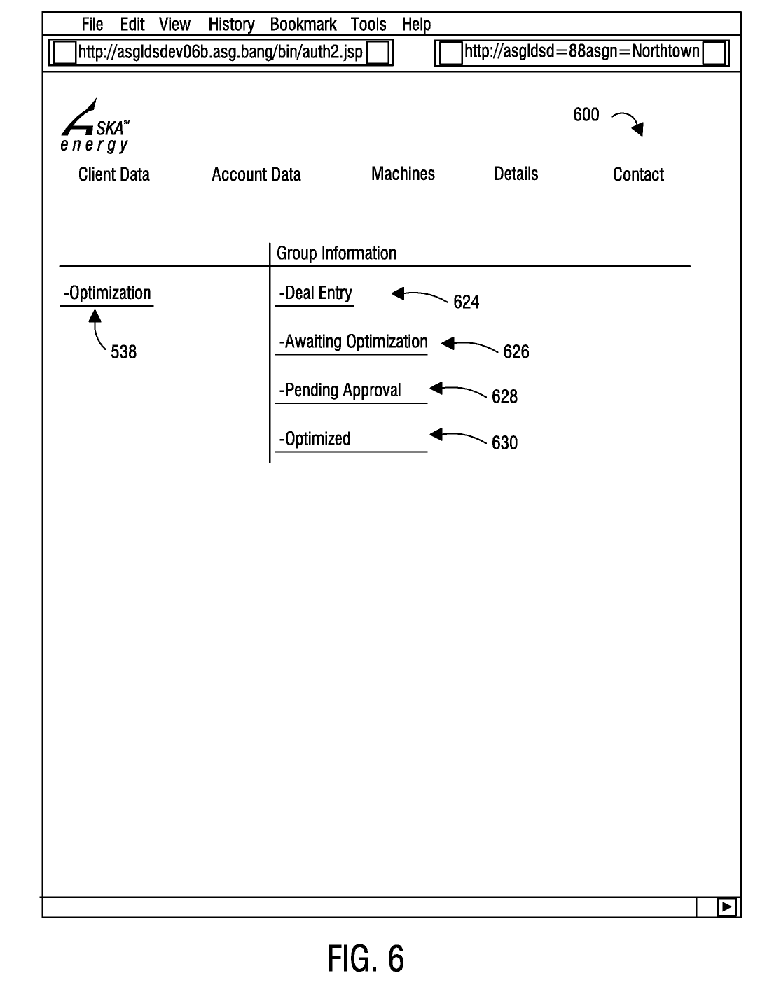

FIG. 6 illustrates another exemplary interface, further providing options for rail shipment optimization, similar to the interface from FIG. 5.

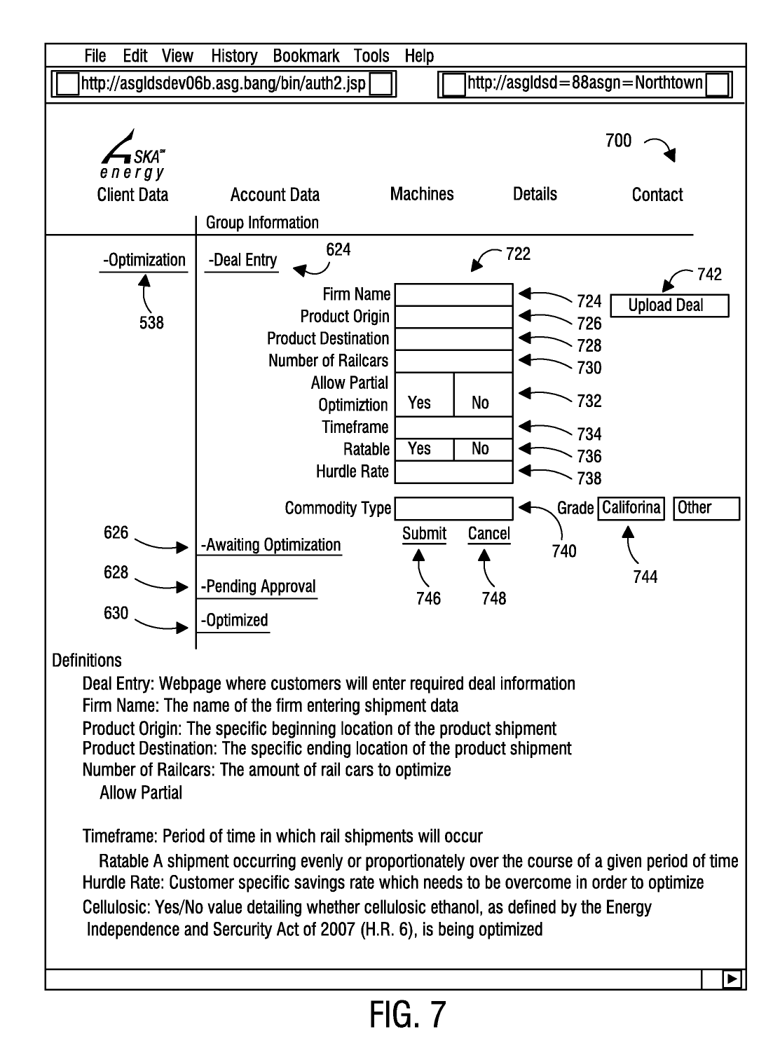

FIG. 7 illustrates an exemplary interface for deal entry in optimizing one or more rail shipments, similar to the interface from FIG. 6.

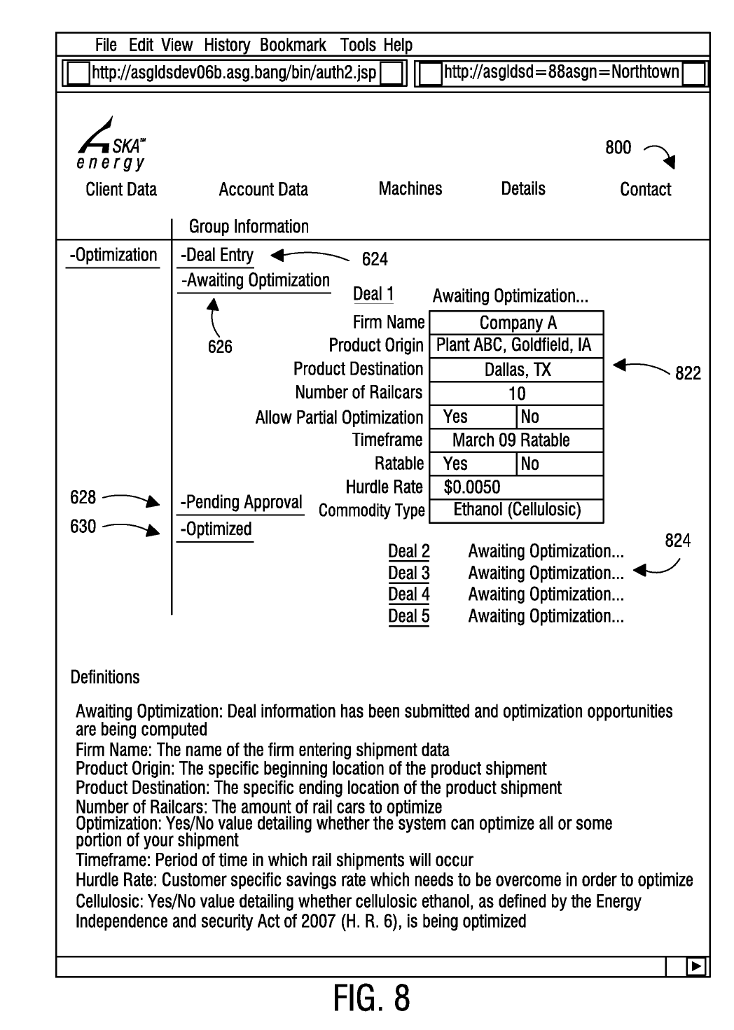

FIG. 8 illustrates an exemplary interface for providing shipment information in optimizing one or more rail shipments, similar to the interface from FIG. 7.

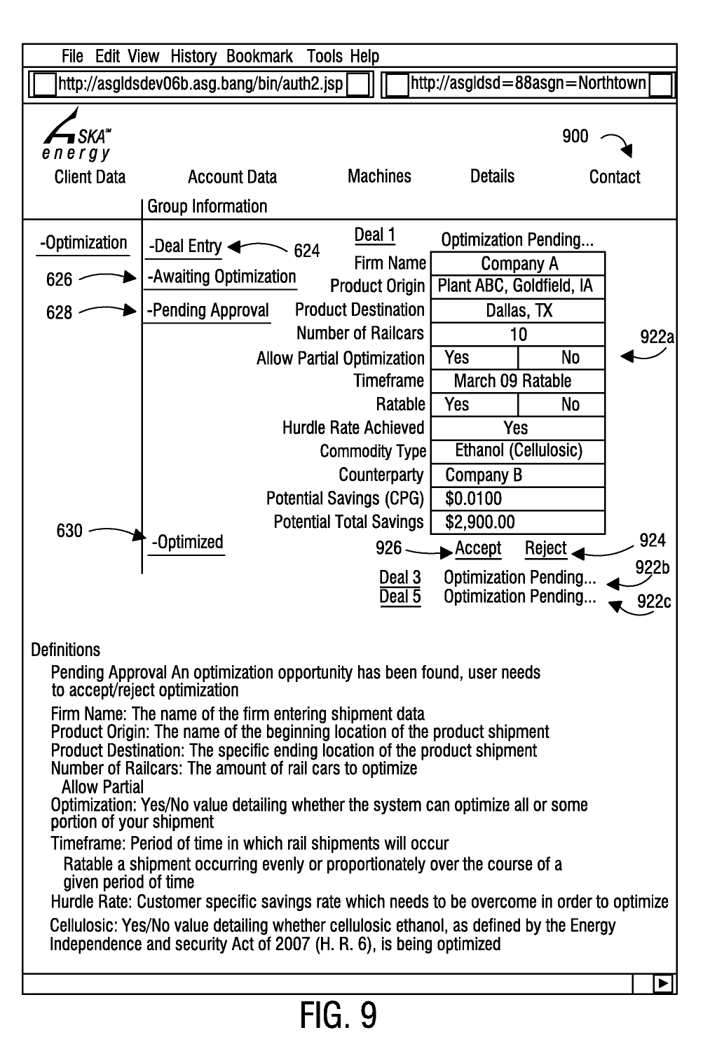

FIG. 9 illustrates an exemplary interface for allowing a user and/or technician to accept shipment criteria, as provided in the interface from FIG. 8.

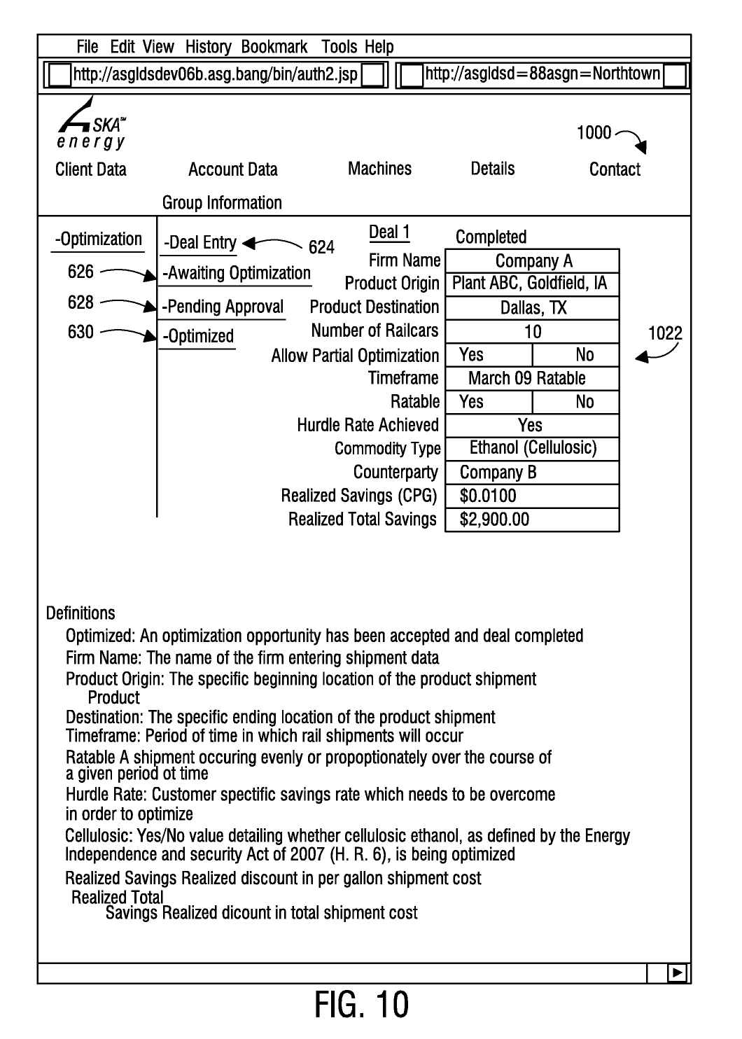

FIG. 10 illustrates an exemplary interface for providing data related to a completed optimization, similar to the diagram from FIG. 9.

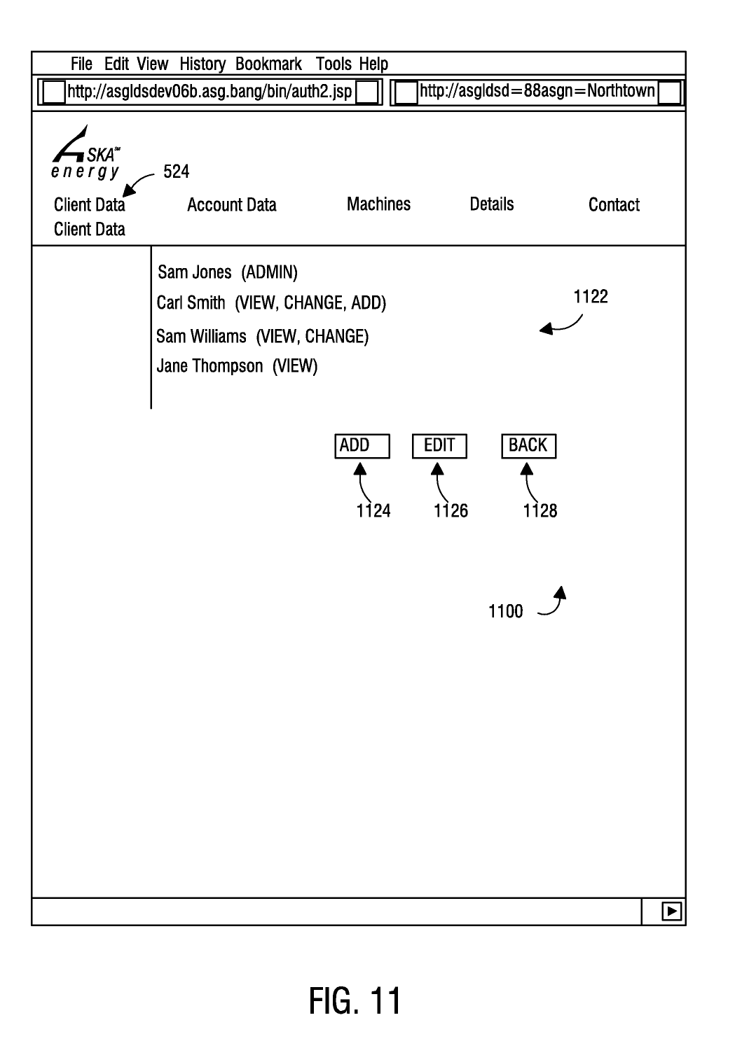

FIG. 11 illustrates an exemplary interface that may be provided in response to selection of the user option in the interface from FIG. 5.

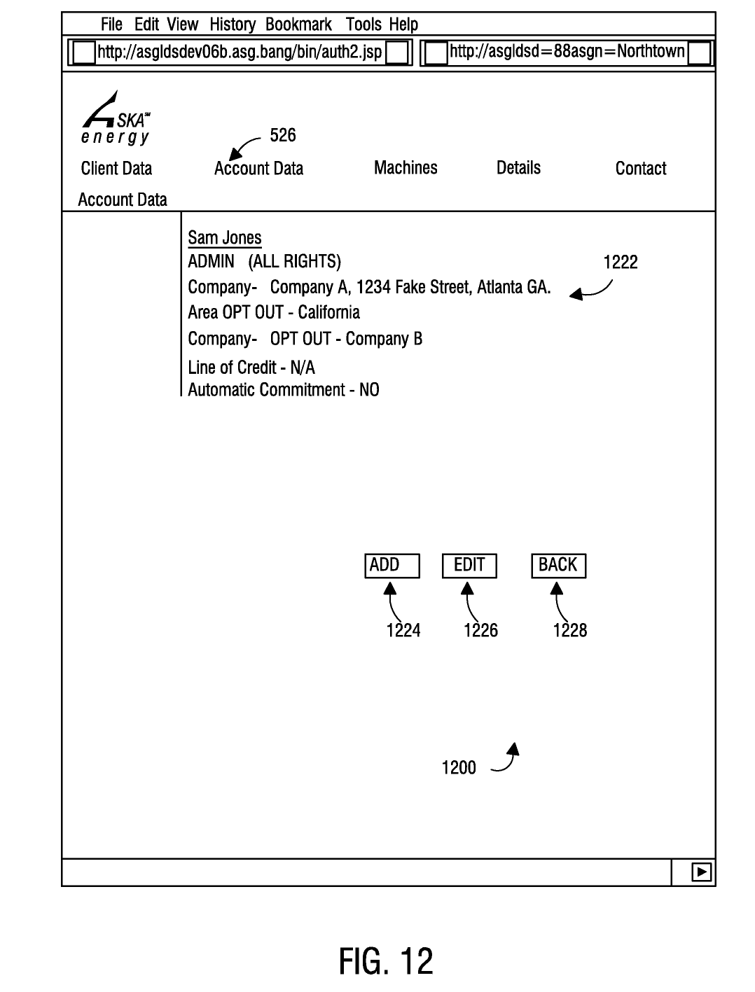

FIG. 12 illustrates an exemplary interface that may be provided in response to selection of the account option in the interface from FIG. 5.

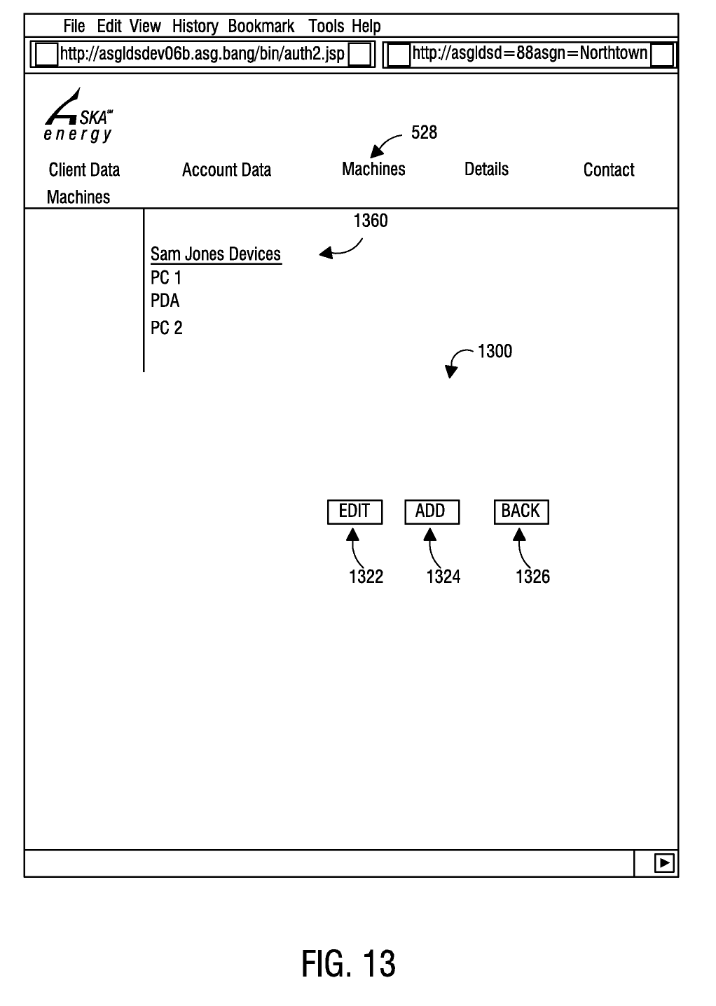

FIG. 13 illustrates an exemplary interface that may be provided in response to selection of the devices option in the interface from FIG. 5.

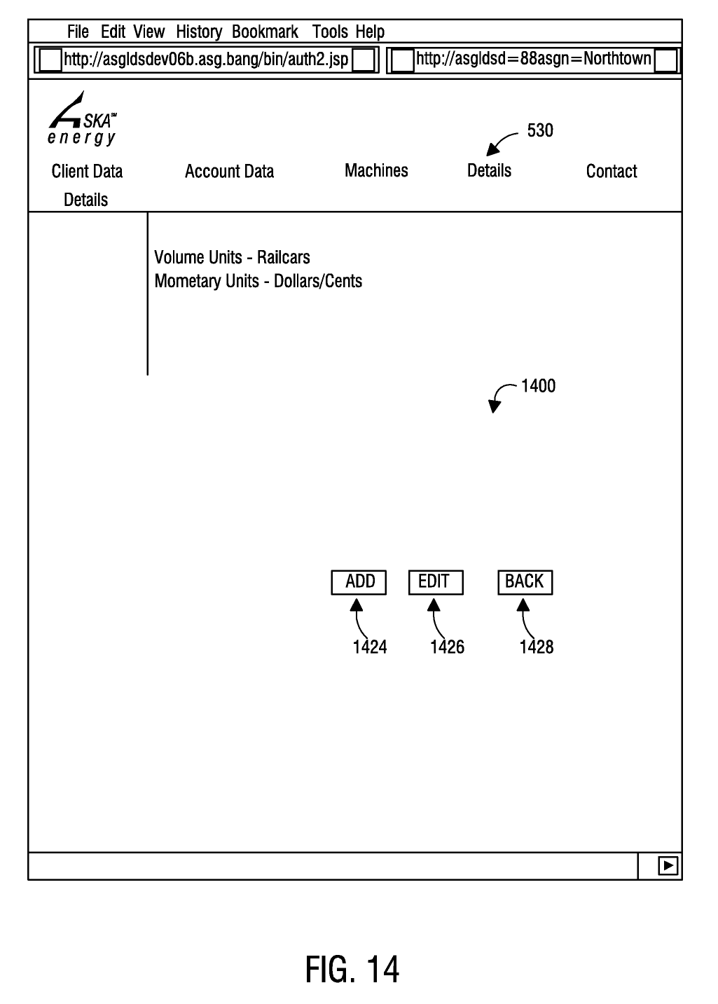

FIG. 14 illustrates an exemplary interface that may be provided in response to selection of the configuration option in the interface from FIG. 5.

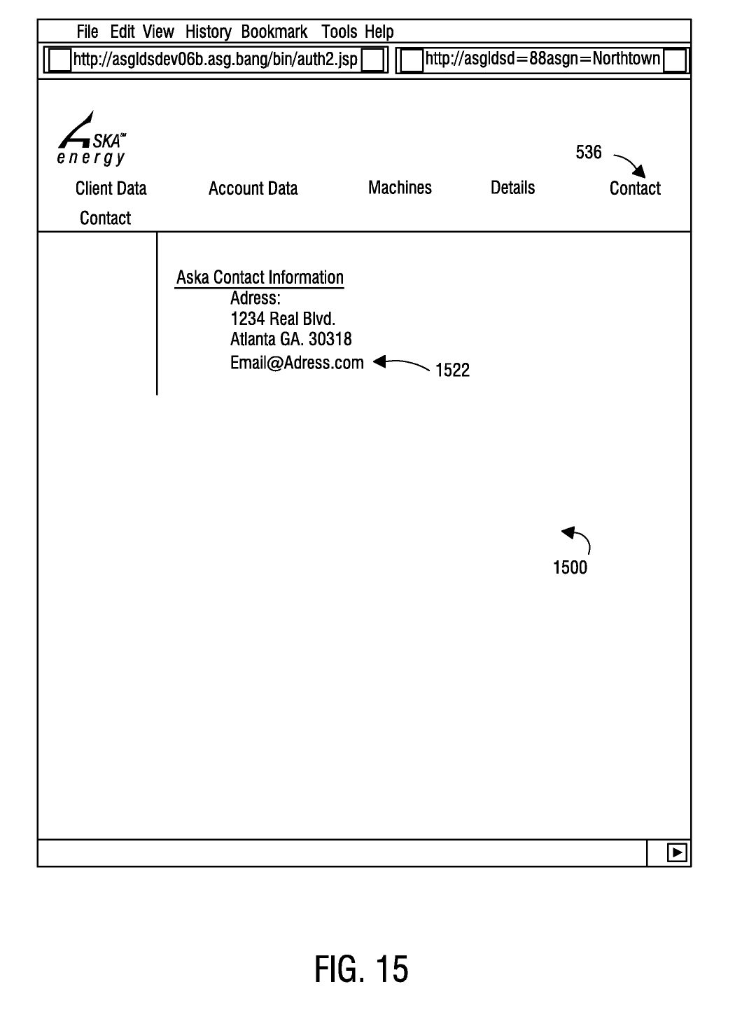

FIG. 15 illustrates an exemplary interface that may be provided in response to selection of the support option in the interface from FIG. 5.

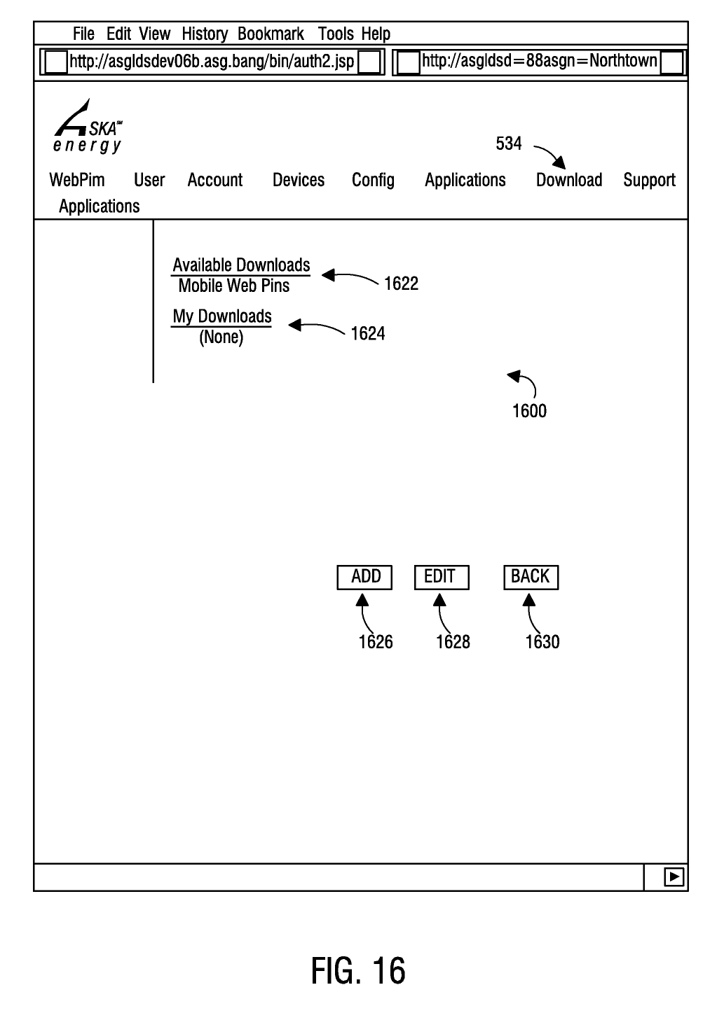

FIG. 16 illustrates an exemplary flowchart for optimizing one or more shipments of commodities, such as may be performed in the network from FIG. 2.

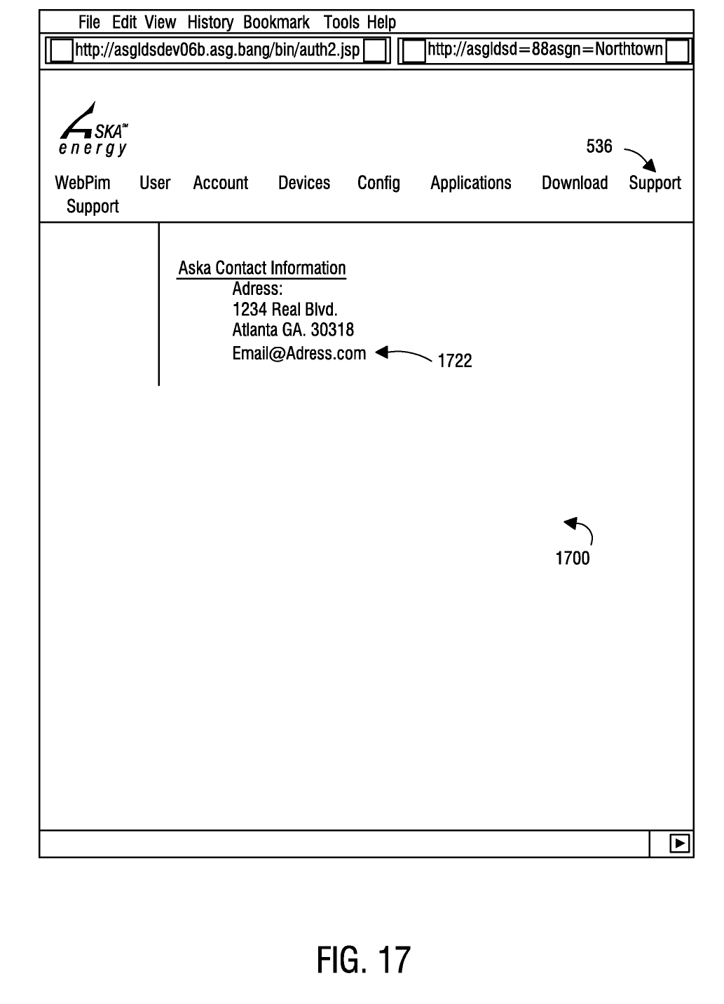

FIG. 17 illustrates an exemplary flowchart for registering an account in a commodity shipment optimization, similar to the flowchart from FIG. 16.

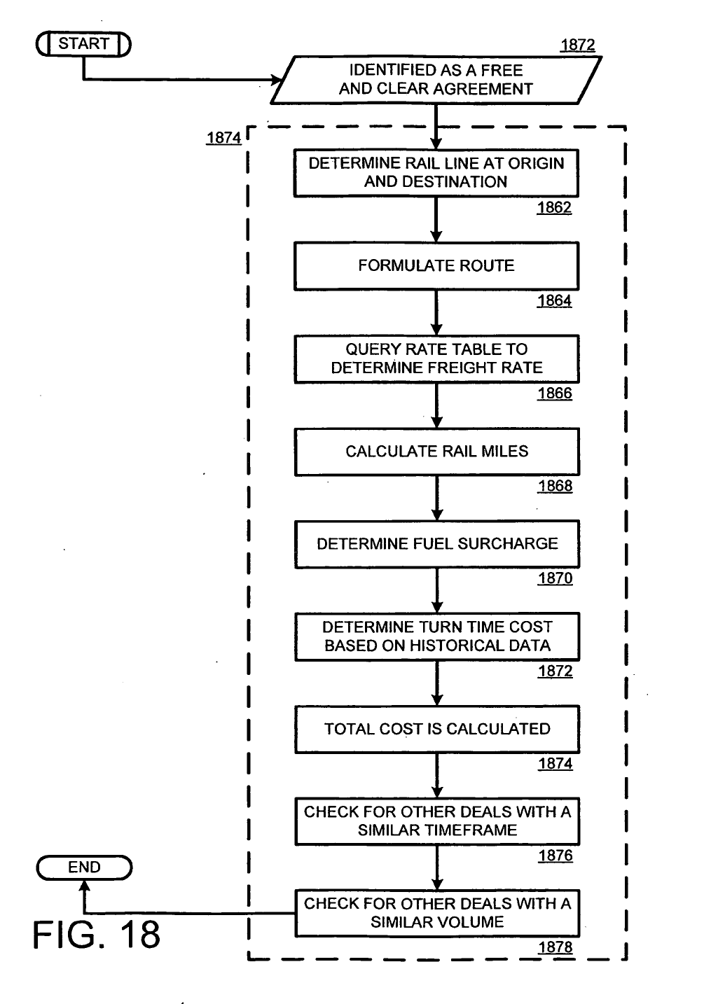

FIG. 18 illustrates an exemplary flowchart for comparing one or more shipping scenarios, similar to the flowchart from FIG. 16.

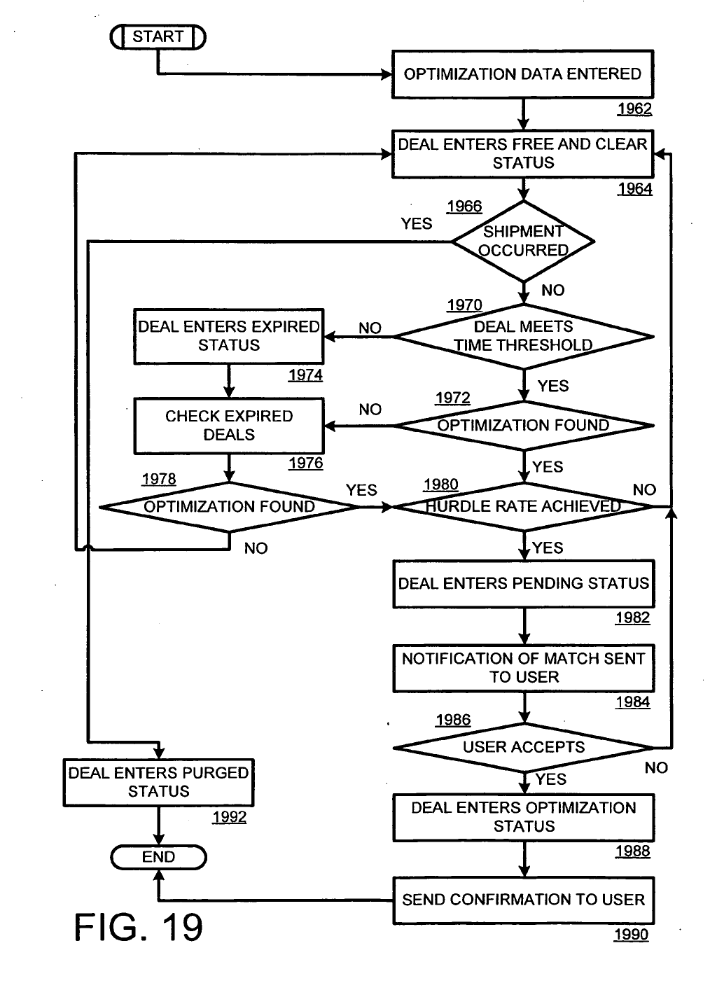

FIG. 19 illustrates an exemplary flowchart for utilizing one or more buckets in optimizing one or more shipments, similar to the flowchart from FIG. 18.

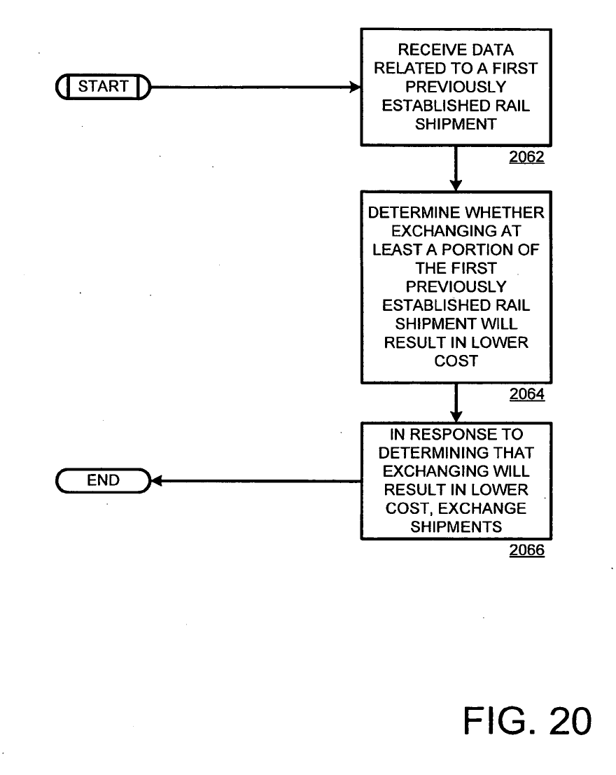

FIG. 20 illustrates an exemplary flowchart optimizing at least one shipment, similar to the diagram from FIG. 19.

### DETAILED DESCRIPTION

Embodiments disclosed herein include logic and/or computing device(s) (e.g., servers) that facilitate optimization of shipments of previously established contracts/obligations for commodities to be delivered by rail. In at least one exemplary embodiment, the logic and/or device(s) may define an optimization system, which may be configured to receive, from a supplier, shipment data regarding a predetermined commodity. The system may also be configured to access the received data to determine if the shipment may be fulfilled by another supplier (who ships the same commodity) in a more efficient manner. If so, the shipment may be reassigned to that supplier and notification may be sent regarding this reassignment. In some embodiments, the reassignment may be achieved by pairing up two suppliers and exchanging their shipments.

Similarly, some embodiments may be configured to coordinate ethanol shipments to more efficiently ship ethanol to recipients. More specifically, Supplier A may enter a contract to ship ethanol from Iowa to Atlanta. Similarly, Supplier B may enter a contract to ship ethanol from Indiana to Dallas. Each of the Suppliers A and B may submit contract and/or shipment information (e.g., origination data, destination data, information related to timing, volume, ratable scheduling requirements, etc.) to the optimization system (manually and/or automatically). Upon receiving this information, the optimization system can determine whether it would be more efficient for the two suppliers to switch their shipments. If so, notification may be sent to the two suppliers of this more efficient shipping scheme and reassign the shipments accordingly (e.g., Supplier A sends the ethanol from Iowa to Dallas and Supplier B sends the ethanol from Indiana to Atlanta). Due to the more efficient shipping scheme, one or both suppliers may realize cost savings. As a nonlimiting example if a first supplier exchanges shipments with a second supplier, each suppler may now be responsible for a less expensive shipment because each shipment may be of a closer proximity to that respective supplier.

Similarly, as more than two suppliers may send contract and/or shipment data to the system, the system may be configured to compare the received data to determine efficient shipment of all the received shipments. Additionally, while in the above nonlimiting example the system reassigned the shipments between two suppliers, some embodiments may be configured to reassign shipments among three or more suppliers.

Further, while some embodiments are directed toward optimization of shipments via an exchange between two suppliers, some embodiments may be directed toward optimization with at least one party who does not coordinate shipments directly with the railroad or who own/leases their own railcars, but still has a defined cost for a commodity to a certain market. Similarly, some embodiments may be directed to a party that provides a commodity at one location for a counterparty in exchange for equivalent amounts of the commodity provided by that counterparty at another site.

Referring now to the drawings, FIG. 1 illustrates an exemplary map, depicting rail lines that may facilitate shipments of commodities. As illustrated in the nonlimiting example of FIG. 1, rail lines in the United States may be configured to transport commodities from an origin to a destination. Depending on the location of the supplier and the location of the recipient, the shipment may utilize one of the rail lines illustrated in FIG. 1. More specifically, if a commodity is scheduled for shipment from Los Angeles to Phoenix, the supplier (and/or recipient) may choose to use the Burlington Northern rail line. However, if a supplier is scheduled to ship a commodity from Los Angeles to Buffalo, there may not be an efficient manner to complete this shipment. More specifically, because the Burlington Northern rail line does not run all the way from Los Angeles to Buffalo, transfers between rail lines might occur, thereby increasing shipment time and cost. Similarly, if another shipment of a similar commodity is scheduled for shipment between Cleveland and San Diego, similar problems may occur.

FIG. 2 illustrates an exemplary network that may be utilized for optimizing rail shipments of commodities, such as via the rail lines from FIG. 1. As illustrated, a client device 202a may be coupled to network 200 and operated by a user. In some embodiments, the user may be a supplier and/or recipient of commodities. While the client device 202a may be configured as a personal computer, some embodiments may be configured with a client device 202b as a laptop computer, with a client device 202c as a wireless computing device, coupled to an access point 220, and/or with other configurations.

Similarly, in some embodiments, the network 200 may include the Internet, a public switched telephone network, a cellular network, a WiMax network and/or other wide area network (wired and/or wireless). Similarly, in some embodiments, the network 200 may include one or more local area networks (wired and/or wireless) to facilitate communication of data among the servers and/or client devices.

Also included in the nonlimiting example of FIG. 2, are a routing server 206a and an optimization server 206b (which may be a local server and/or a remote server). More specifically, in some embodiments, the routing server 206a may be configured to determine a route between a supplier and a recipient. The determined route may be determined as the most likely route, the most economical route, the fewest stops, the fewest transfers, and/or as other criteria.

FIG. 3 illustrates an exemplary optimization server 206b that may be utilized for optimizing rail shipments of commodities, such as the server illustrated in FIG. 2. Although a wire-line device (e.g., the optimization server 206b) is illustrated, this discussion can be applied to wireless devices (and/or other devices), as well. According to exemplary embodiments, in terms of hardware architecture, the optimization server 206b includes a processor 382, a memory component 384, a display interface 394, data storage 395, one or more input and/or output (I/O) device interface(s) 396, and/or one or more network interfaces 398 that are communicatively coupled via a local interface 392. The local interface 392 can include, for example but not limited to, one or more buses and/or other wired or wireless connections. The local interface 392 may have additional elements, which are omitted for simplicity, such as controllers, buffers (caches), drivers, repeaters, and receivers to enable communications. Further, the local interface 392 may include address, control, and/or data connections to enable appropriate communications among the aforementioned components. The processor 382 may be a device for executing software, particularly software stored in the memory component 384. The processor 382 can include any custom made or commercially available processor, a central processing unit (CPU), an auxiliary processor among several processors associated with the optimization server 206b, a semiconductor based microprocessor (in the form of a microchip or chip set), a macroprocessor, and/or generally any device for executing software instructions.

The memory component 384 can include any one or combination of volatile memory elements (e.g., random access memory (RAM, such as DRAM, SRAM, SDRAM, etc.)) and/or nonvolatile memory elements (e.g., flash memory, read only memory (ROM), hard drive, tape, CDROM, etc.). Moreover, the memory component 384 may incorporate electronic, magnetic, optical, and/or other types of storage media. One should note that the memory component 384 can have a distributed architecture (where various components are situated remote from one another), but can be accessed by the processor 382.

The software in the memory component 384 may include one or more separate programs, which may include an ordered listing of executable instructions for implementing logical functions. In the example of FIG. 3, the software in the memory component 384 may include business logic 388 and/or optimization logic 399 (which may include one or more logical components that are executed by a processor), as well as an operating system 386. The operating system 386 may be configured to control the execution of other computer programs and provides scheduling, input-output control, file and data management, memory management, and communication control and related services. The business logic 388 may be configured to execute one or more business rules for an optimization, while the optimization logic 399 may be configured to optimize one or more shipments of commodities, as described in more detail below.

In at least one embodiment, the business logic 388 and/or the optimization logic 399 may be configured as a system component and/or module embodied as software and may also be construed as a source program, executable program (object code), script, and/or any other entity that includes a set of instructions to be performed. When constructed as source programs, the business logic 388 and/or the optimization logic 399 may be translated via a compiler, assembler, interpreter, or the like (which may or may not be included within the memory component 384) so as to operate properly in connection with the operating system 386.

The input/output devices that may be coupled to the system I/O interface(s) 396 may include input devices, for example but not limited to, a keyboard, mouse, scanner, touch screen, microphone, etc. Further, the input/output devices may also include output devices, for example but not limited to, a printer, display, speaker, etc. Additionally, the input/output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more of the network interfaces 398 for facilitating communication with one or more other devices. More specifically, network interface 398 may include any component configured to facilitate a connection with another device. While in some embodiments, among others, the optimization server 206b can include the network interface 398 that includes a personal computer memory card international association (PCMCIA) card (also abbreviated as “PC card”) for receiving a wireless network card, this is a nonlimiting example. Other configurations can include the communications hardware within the optimization server 206b, such that a wireless network card is unnecessary for communicating wirelessly. Similarly, other embodiments include the network interfaces 398 for communicating via a wired connection. Such interfaces may be configured with Universal Serial Bus (USB) interfaces, serial ports, and/or other interfaces.

If the optimization server 206b includes a personal computer, workstation, or the like, the software in the memory component 384 may further include a basic input output system (BIOS) (omitted for simplicity). The BIOS is a set of software routines that initialize and test hardware at startup, start the operating system 386, and support the transfer of data among the hardware devices. The BIOS is stored in ROM so that the BIOS can be executed when the optimization server 206b is activated.

When the optimization server 206b is in operation, the processor 382 may be configured to execute software stored within the memory component 384, to communicate data to and from the memory component 384, and to generally control operations of the optimization server 206b pursuant to the software. Software in the memory component 384, in whole or in part, may be read by the processor 382, perhaps buffered within the processor 382, and then executed.

One should also note that while the description with respect to FIG. 3 includes the optimization server 206b as a single component, this is a nonlimiting example. More specifically, in at least one exemplary embodiment, the optimization server 206b can include a plurality of servers, personal computers, telephones, and/or other devices. Similarly, while the description of FIG. 3 describes the optimization server 206b as a server device, this is also a nonlimiting example. More specifically, depending on the particular exemplary embodiment, other components.

Additionally, while the business logic 388 and the optimization logic 399 are each illustrated in FIG. 3 as including a single software component, this is also a nonlimiting example. In at least one embodiment, the business logic 388 and optimization logic 399 may each include one or more components, embodied in software, hardware, and/or firmware. Additionally, while the business logic 388 and the optimization logic 399 are depicted as residing on a single device, such as the optimization server 206b, the business logic 388 and the optimization logic 399 may reside on one or more devices.

FIG. 4 illustrates an exemplary interface 400 that may be presented to a user and/or technician for optimizing rail shipments of commodities, such as may be presented by the server from FIG. 3. More specifically, before accessing the interface 400, a user (and/or company associated with the user) will have already established an agreement for shipment of a commodity to a recipient. The terms of the shipment agreement may be unique to the particular supplier and recipient and are generally not provided by the optimization system described herein. However, once the shipment agreement is determined (which, depending on the particular configuration may include standardized terms for commodity specifications), the user (which may be a representative of the supplier and/or recipient) may access the interface 400, which may be provided by a web server (e.g., server 206) as part of a web page. The interface 400 may be configured to receive user identification at the user identification prompt 422 and a password at a password prompt 424 for accessing optimization services. Upon receiving the desired information, the optimization server 206b may provide optimization services, as described below.

FIG. 5 illustrates an exemplary interface 500 for facilitating utilization of rail shipments of commodities, similar to the interface from FIG. 4. More specifically, in response to successful authentication of information input by a user in the interface 400 (FIG. 4), the user may be provided with the interface 500 for facilitating optimization of an existing shipment agreement. As illustrated, the interface 500 may include an optimization option 538 to facilitate optimization of an existing deal. Also included in the interface 500 is a client data option 524 for associating users with an account; an account data option 526 for providing information related to the account; a machines option 528 for specifying the devices that may be associated with the current account; a details option 530 for providing configuration information regarding the current account; and a contact option 536 for providing contact information.

FIG. 6 illustrates another exemplary interface 600, further providing options for rail shipment optimization, similar to the interface from FIG. 5. As status in the nonlimiting example of FIG. 6, in response to selection of the optimization option 538 (FIG. 5), one or more status related to group information may be provided. More specifically, the group information may include a deal entry option 624, an awaiting optimization option 626, a pending approval option 628, and an optimized option 630.

FIG. 7 illustrates an exemplary interface 700 for deal entry in optimizing one or more rail shipments, similar to the interface from FIG. 6. As illustrated in the nonlimiting example of FIG. 7, in response to selection of the deal entry option (FIG. 6), an entry form 722 may be provided with one or more options for entering information regarding a new shipment agreement. More specifically, the form 722 may include a firm name field 724 for a user to enter the name of the company that is seeking optimization. As discussed, this entity may be the shipper or the recipient who has at least some control over the shipment. Also included is a product origin field 726 to specify from where the commodity is being shipped. The information in this field may be a general location, such as a city of origin or may be a specific location, such as a plant or warehouse from which the commodity is being sent.

Also included is a product destination field 728. Similar to the product origin field 726, the product destination field 728 may allow the user to specify to where the commodity is being shipped. The information in this field may b ea general location, such as a city of origin or may be a specific location, such as a terminal to which the commodity is being sent. The form 722 may also include a number of railcars field 730. As the commodity is being shipped via rail, the number of railcars may be specified to determine the quantity of the commodity that is being shipped. While the field 730 in this nonlimiting example has a unit of railcars, other indicators of amount (e.g., weight, number of bails, volume, etc.) may also be used, depending on the particular embodiment.

The nonlimiting example of FIG. 7 may also include an allow partial optimization field 732. More specifically, by allowing a partial optimization, the user may allow the optimization server 206b to determine whether any portion of the shipment may be optimized. This may be beneficial if a portion of the shipment can be optimized (e.g., with substantial savings), but the remaining portion of the shipment is not able to be optimized (or not able to be optimized at the same rate). As a nonlimiting example, if the optimization server 206b receives information related to a first shipment that is scheduled for delivery of one railcar on Jan. 1, 2009 from Cleveland to Phoenix and a second shipment of 3 railcars on Jan. 1, 2009 from San Diego to Chicago. The optimization server 206b may determine that the overall optimization would include shipping one railcar from Cleveland to Chicago and one railcar from San Diego to Phoenix. However, because the original shipment from Cleveland to Phoenix includes 3 railcars, the user would have to allow partial optimization in field 732 for this optimization to be implemented.

Also included in the nonlimiting example of FIG. 7 is a timeframe field 734. The timeframe field 734 may be configured for the user to specify a timeframe by which the shipment is scheduled for delivery and/or shipment pickup. Similarly, a ratable field 736 allows the user to indicate whether the shipment agreement is configured for delivery in a plurality of regularly scheduled shipments (e.g., once a week). A hurdle rate field 738 provides an option for the user to determine the savings that the user expects in order to optimize the shipment. More specifically, the user may determine that his/her company will need at least a $0.02 savings per pound of commodity shipped in order for optimization to be worthwhile. Depending on the particular configuration, the hurdle rate may be positive (indicating a savings), negative (indicating a loss), or zero. The form 722 may also include a commodity type field 740 for the user to indicate the commodity being shipped. More specifically, if the shipment involves cellulosic or other type of ethanol, the user may specify this in the commodity type field 740. On a similar token, a grade field 744 may be included to indicate whether the ethanol is of a quality to meet California standards and/or whether the ethanol meets other standards. Similarly, in those embodiments were a commodity other than ethanol is being shipped, other types of commodity specifiers may be utilized.

Also included in the nonlimiting example of FIG. 7 is an upload deal option 742. The upload deal option allows a user to upload the specifics of a previously agreed upon shipment agreement. As the agreement may be embodied in a particular format (e.g., spreadsheet format), by uploading the agreement, the user need not enter the information manually. Upon uploading the agreement, the optimization server 206b can determine whether all of the information in form 722 is present. If so, the form 722 may be automatically populated. If not, the optimization server 206b can provide indication that additional information is requested. Once the information is entered (manually and/or automatically), the user may select the submit option 746 and/or the cancel option 748 to continue. Similarly, some embodiments may be configured to upload the data via a direct link to the optimization server 206b.

FIG. 8 illustrates an exemplary interface 800 for providing shipment information in optimizing one or more rail shipments, similar to the interface from FIG. 7. As illustrated in the nonlimiting example of FIG. 8, after selection of the submit option 746 from FIG. 7, the awaiting optimization option 626 may display the specified parameters of the current deal 822. Additionally, information regarding other deals for the user (and/or the current account associated with that user) 824 may be provided.

FIG. 9 illustrates an exemplary interface 900 for allowing a user and/or technician to accept shipment parameters, as provided in the interface from FIG. 8. More specifically, as illustrated in the nonlimiting example of FIG. 9, upon determining an optimization for the shipment agreement entered in FIG. 6, information regarding the determined optimization may be provided in form 922a, under the pending approval option 628. As illustrated in the form 922a, the optimized shipment may indicate the product origin, new product destination, railcars involved in the optimization, whether partial optimization is allowed, timeframe for the shipment, whether the shipment is ratable, whether the hurdle rate is achieved by this optimization, whether the shipment is cellulosic, the counterparty who is shipping the other portion of the optimized shipment, the potential savings, per gallon, and the total potential savings for the optimization. Also included are options 922b, 922c for other shipments whose optimizations are pending approval. Additionally included are options for the user to accept 926 or reject 924 the proposed optimization.

One should also note that while in the exemplary embodiment of FIG. 9, the user is provided with an option to accept or reject the proposed optimization, this is a nonlimiting example. More specifically, in at least one embodiment, the current account may be configured for automatic acceptance. In such a configuration, the current account may agree beforehand to accept any deal that meets the criteria input in the form 722 (FIG. 7). In such configurations, the accept option 926 and the reject option 924 (and potentially the interface 900) may be excluded.

FIG. 10 illustrates an exemplary interface 1000 for providing data related to a completed optimization, similar to the diagram from FIG. 9. As illustrated, the interface 1000 may be provided in response to selection of the accept option 926 and include the information agreed upon 1022 in the accepted optimization.

FIG. 11 illustrates an exemplary interface 1100 that may be provided in response to selection of the client data option 524 in the interface 500 from FIG. 5. As illustrated in the nonlimiting example of FIG. 11, upon selection of the client data option 524 (FIG. 5), a list of users associated with the current account may be provided. More specifically, the current account may be with company A. Company A may have one or more registered users who may facilitate optimization of shipment agreements. In users section 1122 of the interface 1100, the registered users for the current account are Sam Jones, Carl Smith, Sam Williams, and Jane Thompson. Additionally, next to each user is listed the rights that respective user has been assigned. More specifically, Sam is designated as the administrator and thus has all rights. Carl has been granted the right to view, change, and add new shipments. Sam has the ability to view and/or change shipment parameters. Jane has only been granted the right to view existing orders.

Also included in the nonlimiting example of FIG. 11 is an add option 1124, an edit option 1126, and a back option 1128. The add option may allow a user (e.g., the administrator) to add new users to the current account. The edit option 1126 may be configured to provide a user with the ability to edit the rights of existing users and/or remove users from the current account. The back option 1128 may be configured to advance to a previous interface.

FIG. 12 illustrates an exemplary interface 1200 that may be provided in response to selection of the account data option 526 in the interface 500 from FIG. 5. As illustrated, in response to selection of the account data option 526, the user may be provided with various criteria regarding the current account. More specifically, the current account may have Sam Jones as an administrator. The current account may belong to Company A with an address of 1234 Fake Street, Atlanta, Ga. The current account may have opted out of all transactions in California. The current account may have also opted out of all transactions with Company B. Additionally, the current account may not be signed up for automatic acceptance of optimized shipments.

Also included in the nonlimiting example of FIG. 12 is an add option 1224 for adding additional account parameters, an edit option 1226 for editing the existing account parameters, and a back option 1228 for returning to a previous interface.

FIG. 13 illustrates an exemplary interface 1300 that may be provided in response to selection of the machines option 528 in the interface 500 from FIG. 5. As illustrated in the nonlimiting example of FIG. 13, upon selection of the machines option 528, a list of devices for the user may be presented in the devices section 1360. More specifically, this option may allow for varying levels of security based on whether the user (in this case Sam Jones) is logging on via one of the listed devices. Additionally, personal settings may be provided based on the device by which the user is accessing the business logic 388 and/or the optimization logic 399. Also included are an edit option 1322, for editing the listed devices, an add option 1324 for adding new devices, and a back option 1326 for returning to a previous interface.

FIG. 14 illustrates an exemplary interface 1400 that may be provided in response to selection of the details option 530 in the interface 500 from FIG. 5. As illustrated, upon selection of the details option 530, one or more configuration parameters may be provided. As a nonlimiting example, volume units, monetary units, opt in/out states and/or other configuration parameters. Also included is an add option 1424 for adding additional configuration criteria, an edit option 1426 for editing the configuration parameters, and a back option 1428 for returning to a previous interface.

FIG. 15 illustrates an exemplary interface 1500 that may be provided in response to selection of the support option 536 in the interface from FIG. 5. As illustrated, in response to selection of the support option 536, contact information 1522 regarding the optimization system may be provided.

FIG. 16 illustrates an exemplary flowchart for optimizing one or more shipments of commodities, such as may be performed in the network from FIG. 2. As illustrated in the nonlimiting example of FIG. 16, a user may log onto the optimization platform (block 1662). The optimization server 206b may then determine whether the user is a registered user (block 1664). If the user is not a registered user, the optimization server 206b can provide an option for the user to register and determine whether the user has registered (block 1666). If not, the process returns to block 1666. If however, the user registers, the optimization server 206b records the registration information (block 1668) and provides an option for optimization data entry of a current commodity shipment agreement (block 1670). Similarly, if at block 1664, the user is registered, the optimization server 206b provides an option for optimization entry (block 1670). As discussed above (e.g., FIG. 7), optimization data entry may include entering (and/or uploading) data regarding the current commodity shipment agreement for optimization.

Upon receiving the shipment agreement information, the shipment agreement information is identified as a free and clear agreement (block 1672). More specifically, a free and clear agreement indicates that the agreement is eligible for optimization. The current shipment may then be compared with other free and clear agreements (block 1674) to determine whether any of the free and clear agreements can be optimized and, if so, which agreements can be compared to provide the most desirable optimization.

In at least one exemplary embodiment, the process can include the optimization server 206b communicating with the routing server 206a to determine a most likely route for shipping the commodities for each free and clear agreement. Each of these routes can be compared with every combination (and/or permutation) of shipments that have been identified as free and clear. More specifically, depending on the particular configuration, the optimization server can compare each of the free and clear agreements with each of the other free and clear agreements and determine the scenario that is most efficient as a whole. Similarly, in some embodiments, the optimization server 206b can determine a highest priority client and provide the greatest optimization for the free and clear agreement for that client. The next highest priority client can then be optimized in a similar fashion. Determination of the highest priority client may be based on any of a plurality of factors including, money spent with the optimization system, number of transactions with the optimization system, ship date, and/or other based on other criteria.

If at block 1676, an optimization is not found for the current commodity shipment agreement, the optimization server 206b can check expired agreements (block 1678). More specifically, if in the timeframe field 734, the user indicated a date that has already expired, the agreement is considered expired. If not, the process returns to block 1674 to wait for additional free and clear agreements to be received. However, if an optimization is found (block 1680 and block 1676), the optimization server 206b can determine if the optimization achieves the hurdle rate specified in the hurdle rate field 738 of FIG. 7 (block 1682). If not, the process returns to block 1674. If the hurdle rate is achieved, the agreement enters pending status (block 1684). Notification of the match may then be sent to the user (block 1686). The optimization server 206b may then determine whether the user accepts the optimization (block 1688). As discussed above, depending on the particular configuration, acceptance may be automatic or manual. If the user does not accept, the process returns to block 1674. If the user does accept, the shipment is optimized (block 1690) and confirmation is sent to the user (block 1692). Because the optimization will generally involve two or more parties, each of the parties may be notified.

One should note that by checking expired deals at block 1678, the optimization server 206b recognizes that these deals are no longer applicable. However, in certain situations, the user may have incorrectly entered the timeframe in the timeframe field 734, the agreement may have changed, and/or there is flexibility in the agreement that could allow for a later delivery date.

One should also note that depending on the particular configuration, the optimization system may request payment from users whose shipments are optimized. In those embodiments, the payment structure may include a percentage of each optimization, a percentage of a plurality of optimizations for a particular user, a fixed fee, and/or may include other payment structure.

One should also note that, in at least some embodiments, comparison of the current commodity shipment agreement with other free and clear agreements may be limited based on counterparties (e.g., other suppliers) with which the user has specified. More specifically, if the user of Company A has indicated that they will only optimize with Company B and Company C, the comparison will be only with deals that involve those companies.

FIG. 17 illustrates an exemplary flowchart for activating an account in a commodity shipment optimization, similar to the flowchart from FIG. 16. More specifically, from block 1868 in FIG. 18, the user can navigate to a registration page (block 1762). The user can set up an account (block 1764). The basic information (e.g., name, address, etc.) may then be submitted to the optimization server 206b (block 1766). The account may then be registered (block 1768). After the account is registered, detailed information (e.g., other users that may access the current account, etc.) may be entered and submitted (block 1770). The user may then be provided with an option to approve the counterparties with whom the current account can optimize (block 1772). The user can then define credit terms with the approved counterparties (block 1774).

More specifically, in at least one embodiment, upon determining the designated counterparties, optimization may first look to those parties for optimization. If no suitable optimization is available, the optimization server 206b may then determine whether other registered users (who are not counterparties of the user) have shipments that may be used for optimization of this shipment. As a nonlimiting example, during registration, the user (of Company A) may specify that Company A will optimize shipments with Company B and Company C. Upon submitting a commodity shipment agreement for optimization, the optimization server 206b may first look to Company B and Company C for optimization. If an optimization that meets the criteria is available, the optimization server 206b may optimize the two (or more) shipments. If however, no optimization is available, the optimization server 206b may search other registered accounts for an optimization (e.g., Company D).

After the credit terms are defined, the user can choose applicable originations and/or destinations (block 1776). More specifically, if the user will not ship commodities to California, the user may indicate so, to prevent the optimization server 206b from optimizing with deals in California. Similarly, if there is a geographic area that the user prefers to ship, that may also be indicated. Once the destinations are specified, the account may be activated (block 1778).

FIG. 18 illustrates an exemplary flowchart for comparing one or more shipping scenarios, similar to the flowchart from FIG. 16. As illustrated from FIG. 16, the current commodity shipment agreement is identified as a free and clear agreement (block 1872). As also illustrated in FIG. 18, the process can then proceed to block 1874 to compare the current commodity shipment agreement with other free and clear agreements. More specifically, the optimization server 206b can determine a rail line at the origin and destination of the current commodity shipment (block 1862). A route may be formulated for this shipment (block 1864). More specifically, in at least one embodiment, the optimization server 206b can query the routing server 186a for a most likely route between the origin and destination. The optimization server 206b can then query a rate table (local and/or remote to optimization server 206b) to determine a freight cost of the shipment (block 1866). The optimization server 206b (e.g., via business logic 388) can also calculate rail in miles in the determined route (block 1868). Additionally, the optimization server 206b can query a fuel surcharge table at local and/or remote optimization server 206b to determine an expected fuel surcharge for the current commodity shipment (block 1870). The optimization server 206b may determine a turn time cost based on historical data (block 1872). From this information, the optimization server 206b can calculate a total cost of the current shipment (block 1874). The optimization server 206b can then compare the total cost (and other data) of the current shipment with other shipment agreements with the same time frame (block 1876) The optimization server 206b can also check for other shipment agreements with a similar volume (block 1878).

FIG. 19 illustrates an exemplary flowchart for utilizing one or more buckets in optimizing one or more shipments, similar to the flowchart from FIG. 18. As illustrated in the nonlimiting example of FIG. 19, optimization data related to a current shipment agreement may be entered (block 1962). The shipment agreement may enter free and clear status (block 1964). The optimization server 206b can then determine whether a shipment has occurred (block 1966). If so, the shipment may enter purged status and the process (block 1992) may end. If however, the shipment has not occurred, the optimization server 206b determines whether the shipment agreement meets a time threshold (block 1970). More specifically, in at least one embodiment, in order for the current shipment agreement to be optimized with another shipment agreement, the user may specify a date and time by which an optimization may be found. If the agreement does not meet the date and time threshold, the shipment enters expired status (block 1974). The optimization server 206b can then check expired deals (block 1976) to determine whether any shipments that have entered expired status could be optimized with the current shipment (block 1978). If no, the process returns to block 1964. If so, the process proceeds to block 1980.

At block 1980, the optimization server 206b determines whether a hurdle rate is achieved. If not, the process returns to block 1964. If the hurdle rate is achieved, the shipment agreement enters pending status (block 1982). The optimization server 206b may then send notification of an optimization match to a user (block 1984). The optimization server 206b can then determine whether the user accepts the proposed optimization (block 1986). As discussed above, this may be an automatic acceptance or a manual acceptance. If the user does not accept, the process returns to block 1964. If however, the user accepts the proposed optimization, the deal enters optimization status (block 1988). The optimization server 206b can then send confirmation to the user (block 1990).

FIG. 20 illustrates an exemplary flowchart optimizing at least one shipment, similar to the diagram from FIG. 19. As illustrated, the optimization server 206b can receive data related to a first previously established rail shipment (block 2062). The shipment may have been previously established by a company who has an account with the optimization server 206b. Additionally, the optimization server 206b can determine whether exchanging at least a portion of the first previously established rail shipment with a shipment from another account will result in lower cost for at least one of the parties (block 2064). More specifically, the optimization server 206b may be configured to store (and/or have access to a storage device that stores) data regarding shipments for one or more other accounts. As discussed above, if the optimization server 206b determines that an optimization is available, the optimization server 206b can facilitate exchanging shipments (block 2066).

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), a linear program, etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A computer-implemented method for optimization of at least one previously established rail shipment of a commodity, comprising:
receiving data related to a first previously established rail shipment, the first previously established rail shipment including a first origin and a first destination, the first previously established rail shipment being established by a first supplier;
determining whether exchanging at least a portion of the first previously established rail shipment with a second previously established rail shipment that is established by a second supplier will result in lower shipment costs for at least one of the first supplier and the second supplier, the second previously established rail shipment including a second origin and a second destination; and
in response to a determination that exchanging at least a portion of the first previously established rail shipment with the second previously established rail shipment will result in lower shipment costs for at least one of the first supplier and the second supplier, exchanging at least a portion of the first previously established rail shipment with the second previously established rail shipment such that the first supplier facilitates shipment of commodities from the first origin to the second destination and the second supplier facilitates shipment of commodities from the second origin to the first destination.

2. The computer-implemented method of claim 1, wherein determining whether exchanging at least a portion of the first previously established rail shipment with a second previously established rail shipment will result in lower shipment costs for at least one of the first supplier and the second supplier includes comparing the first origin and the first destination with the second origin and the second destination.

3. The computer-implemented method of claim 1, wherein receiving data related to the first previously established rail shipment includes receiving a hurdle rate threshold from the first supplier that indicates a minimum savings required for exchanging shipments.

4. The computer-implemented method of claim 3, wherein determining whether exchanging at least a portion of the first previously established rail shipment with a second previously established rail shipment will result in lower shipment costs for at least one of the first supplier and the second supplier includes determining whether the hurdle rate threshold is met.

5. The computer-implemented method of claim 1, wherein receiving data related to the first previously established rail shipment includes receiving a timeframe for delivery of the first previously established rail shipment.

6. The computer-implemented method of claim 1, wherein the commodity includes ethanol.

7. The computer-implemented method of claim 1, further comprising, in response to a determination that exchanging at least a portion of the first previously established rail shipment with the second previously established rail shipment will not result in lower shipment costs for at least one of the first supplier and the second supplier, determining whether exchanging at least a portion of the first previously established rail shipment with a third previously established rail shipment that was established by a third supplier will result in lower shipment costs for at least one of the first supplier and the third supplier.

8. A system for optimization of at least one previously established rail shipment of a commodity, comprising:
a memory component configured to store at least the following:
receiving logic configured to receive data related to a first previously established rail shipment, the first previously established rail shipment including a first origin and a first destination, the first previously established rail shipment being established by a first supplier;
first determining logic configured to determine whether exchanging at least a portion of the first previously established rail shipment with a second previously established rail shipment that is established by a second supplier will result in greater efficiency for at least one of the first supplier and the second supplier, the second previously established rail shipment including a second origin and a second destination; and
exchanging logic configured to, in response to a determination that exchanging at least a portion of the first previously established rail shipment with the second previously established rail shipment will result in greater efficiency for at least one of the first supplier and the second supplier, exchange at least a portion of the first previously established rail shipment with the second previously established rail shipment such that the first supplier facilitates shipment of commodities from the first origin to the second destination and the second supplier facilitates shipment of commodities from the second origin to the first destination.

9. The system of claim 8, wherein determining whether exchanging at least a portion of the first previously established rail shipment with a second previously established rail shipment will result in greater efficiency for at least one of the first supplier and the second supplier includes comparing the first origin and the first destination with the second origin and the second destination.

10. The system of claim 8, wherein receiving data related to the first previously established rail shipment includes receiving a hurdle rate threshold from the first supplier that indicates a minimum savings required for exchanging shipments.

11. The system of claim 10, wherein determining whether exchanging at least a portion of the first previously established rail shipment with a second previously established rail shipment will result in greater efficiency for at least one of the first supplier and the second supplier includes determining whether the hurdle rate threshold is met.

12. The system of claim 8, wherein receiving data related to the first previously established rail shipment includes receiving a timeframe for delivery of the first previously established rail shipment.

13. The system of claim 8, wherein the commodity includes ethanol.

14. The system of claim 8, further comprising, second determining logic configured to, in response to a determination that exchanging at least a portion of the first previously established rail shipment with the second previously established rail shipment will not result in greater efficiency for at least one of the first supplier and the second supplier, determine whether exchanging at least a portion of the first previously established rail shipment with a third previously established rail shipment that was established by a third supplier will result in greater efficiency for at least one of the first supplier and the third supplier.

15. A computer-readable storage medium for optimization of at least one previously established rail shipment of a commodity that stores a computer program that, when executed by a computer, causes the computer to perform at least the following:
receive data related to a first previously established rail shipment, the first previously established rail shipment including a first origin and a first destination, the first previously established rail shipment being established by a first supplier;
determine whether exchanging at least a portion of the first previously established rail shipment with a second previously established rail shipment established by a second supplier will result in lower shipment costs for at least one of the first supplier and the second supplier, the second previously established rail shipment including a second origin and a second destination; and
in response to a determination that exchanging at least a portion of the first previously established rail shipment with the second previously established rail shipment will result in lower shipment costs for at least one of the first supplier and the second supplier, exchange at least a portion of the first previously established rail shipment with the second previously established rail shipment such that the first supplier facilitates shipment of commodities from the first origin to the second destination and the second supplier facilitates shipment of commodities from the second origin to the first destination.

16. The computer-readable storage medium of claim 15, wherein determining whether exchanging at least a portion of the first previously established rail shipment with a second previously established rail shipment will result in lower shipment costs for at least one of the first supplier and the second supplier includes comparing the first origin and the first destination with the second origin and the second destination.

17. The computer-readable storage medium of claim 15, wherein receiving data related to the first previously established rail shipment includes receiving a hurdle rate threshold from the first supplier that indicates a minimum savings required for exchanging shipments.

18. The computer-readable storage medium of claim 17, wherein determining whether exchanging at least a portion of the first previously established rail shipment with a second previously established rail shipment will result in lower shipment costs for at least one of the first supplier and the second supplier includes determining whether the hurdle rate threshold is met.

19. The computer-readable storage medium of claim 15, wherein receiving data related to the first previously established rail shipment includes receiving a timeframe for delivery of the first previously established rail shipment.

20. The computer-readable storage medium of claim 15, wherein the commodity includes ethanol.

21. A computer-implemented method for optimization of at least one previously established rail shipment of a commodity, comprising:
receiving data related to a first previously established rail shipment the first previously established rail shipment established via a first supplier; and
exchanging at least a portion of the first previously established rail shipment with a second previously established rail shipment.
